(19) United States
(12) Patent Application Publication
(10) Pub. No.: US 2012/0066068 A1
(43) Pub. Date: Mar. 15, 2012

(54) Advertisement Delivery System Based on Electronic Coupon

(76) Inventor: Yang Pan, Singapore (SG)

(21) Appl. No.: 12/881,197

(22) Filed: Sep. 14, 2010

(51) Int. Cl. G06Q 30/00

(52) U.S. Cl. 705/14.64; 705/14.1; 705/26.1

(57) ABSTRACT

A method of delivering advertisements to a user of mobile communication device is disclosed. An electronic coupon is transmitted from an electronic terminal to a mobile device carried by a user. The electronic coupon may include an advertising message. The received coupon may be displayed on a screen of the mobile device as an icon. The received coupons may be organized in a hierarchical manner. The user may select the icon to display an image of the coupon including the advertising message. The user may further select the advertising message for more details. In accordance with one implementation, the coupon value may be increased if the advertising message is viewed by the user. In accordance with another implementation, a new coupon may be delivered to the mobile device.

### CROSS-REFERENCE TO RELATED APPLICATIONS

Not applicable.

### BACKGROUND-FIELD OF INVENTION

This invention relates generally to advertising. More specifically, the invention relates to methods for delivering an advertisement to a user of a mobile communication device.

### BACKGROUND-DESCRIPTION OF PRIOR ART

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising message accordingly.

### SUMMARY

It is an object of the present invention to provide a method of delivering an advertising message using an electronic coupon, wherein the coupon may be displayed as an icon on a display of the mobile communication device.

It is another object of the present invention to provide a method of displaying an advertising message on an electronic coupon and subsequently displaying next level of details upon the user's selection of the message.

It is yet another object of the present invention to provide a method of delivering advertising messages, wherein the user's action of viewing the message may be rewarded by increasing the value of the electronic coupon or by receiving a new coupon.

According to one embodiment of the present invention, an advertisement delivery system comprises a mobile communication device carried by a user and an electronic terminal operated by a retailer. The terminal and the mobile device may be connected during a commercial transaction through a communication link. According to one implementation of the present invention, the communication link is an ad hoc communication link such as, for example, the Bluetooth type of connection. An electronic coupon may be delivered from the terminal to the mobile device.

The electronic coupon may include an advertising message. The received coupon may be displayed as an icon on a display of the mobile device. Upon the user's selection of the icon, an image of the electronic coupon is displayed. The user may select the displayed advertising message to receive the next level of details. According to one implementation, after the user views the message, the value of the coupon may be increased to reward the user's action. A new advertising message may be displayed afterwards. According to another implementation, a new coupon may be delivered to the mobile device. The new coupon may also include another advertising message. The advertising message associated with the coupon may be updated regularly by a data manager through a communication network.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary advertisement delivery system;

FIG. 2 is a schematic diagram illustrating that the received coupon is displayed as an icon on a display of the mobile device and the coupon may include coupon messages and advertising messages;

FIG. 3 is a schematic diagram illustrating operations of displaying advertising messages;

FIG. 4 is an exemplary illustration that electronic coupons may be organized in a hierarchical manner;

FIG. 5 is a flowchart illustrating an exemplary process that an electronic coupon including an advertising message is delivered from an electronic terminal to a mobile device;

FIG. 6 is a flowchart illustrating an exemplary process that at least two levels of advertising message may be delivered to the user of the mobile device based on the electronic coupon;

FIG. 7 is a flowchart illustrating an exemplary process that the value of the electronic coupon may be increased to reward the user's action of viewing the advertising message;

FIG. 8 is a flowchart illustrating another exemplary process that a new coupon may be delivered to the user to reward the user's action of viewing the advertising message.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

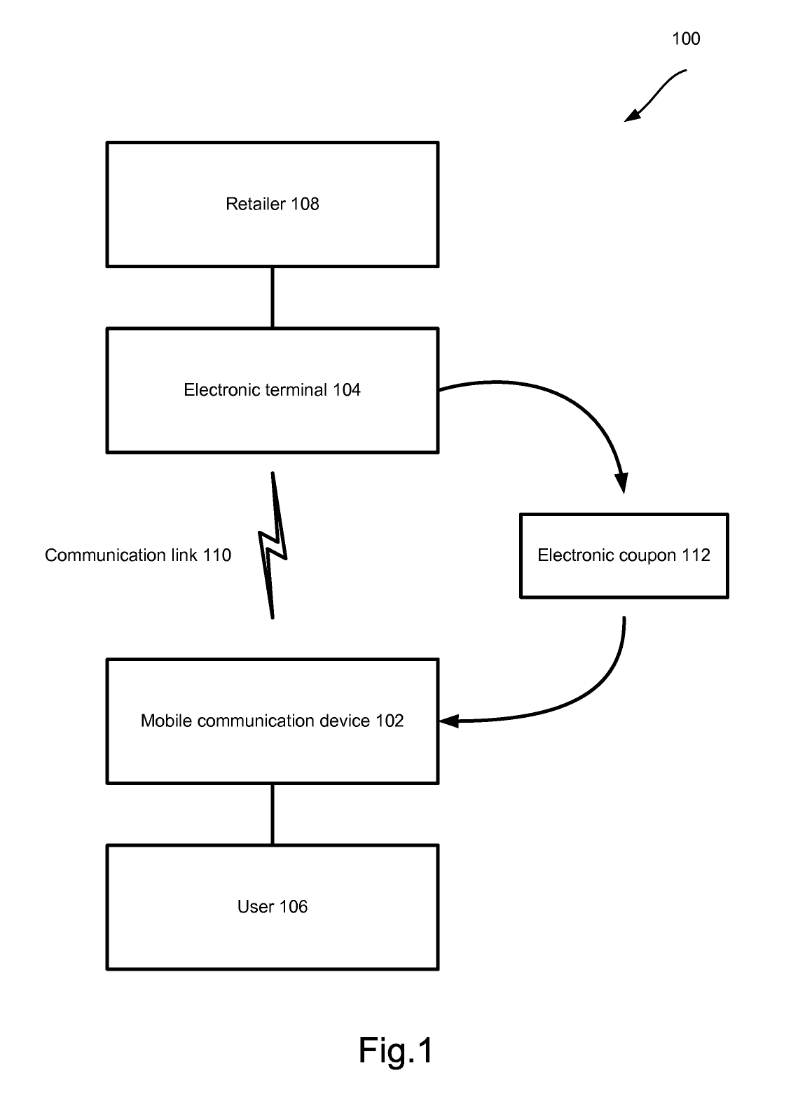

FIG. 1 is a schematic diagram of an exemplary advertisement delivery system for delivering advertisements based on an electronic coupon. The system 100 comprises a mobile communication device 102. The mobile communication device may be a smart phone according to one implementation of the present invention. The mobile communication device may also be anyone of the other mobile devices such as, for example, a tablet computer, a laptop computer and a handheld media player. The system further comprises an electronic terminal 104. The terminal may be located near a casher of a retailer. The mobile device 102 is carried by a user (shopper) 106 and the electronic terminal 104 may be operated by the retailer 108. The mobile device 102 and the terminal 104 are connectable through a communication link 110. The communication link may be an ad hoc communication link according to one embodiment of the present invention. The ad hoc communication link includes the Bluetooth type of connection (IEEE 802.15.1 and its amendments), the ZigBee type of connection (IEEE 802.15.4 and its amendments), and a WiFi type of connection (IEEE 802.11n). The ad hoc communication link 110 may further include a Near-Field-Communication (NFC, ISO/IEC 14443 and ISO 18000-3) comprising a RF reader in the electronic terminal 104 and a RFID in the mobile device 102 or vice versa.

According to another embodiment of the present invention, the communication link 110 may be a private and/or a public communication network including a public telephone network and the Internet.

An electronic coupon 112 including an advertising message may be delivered from the electronic terminal 104 to the mobile device 102 after they are connected.

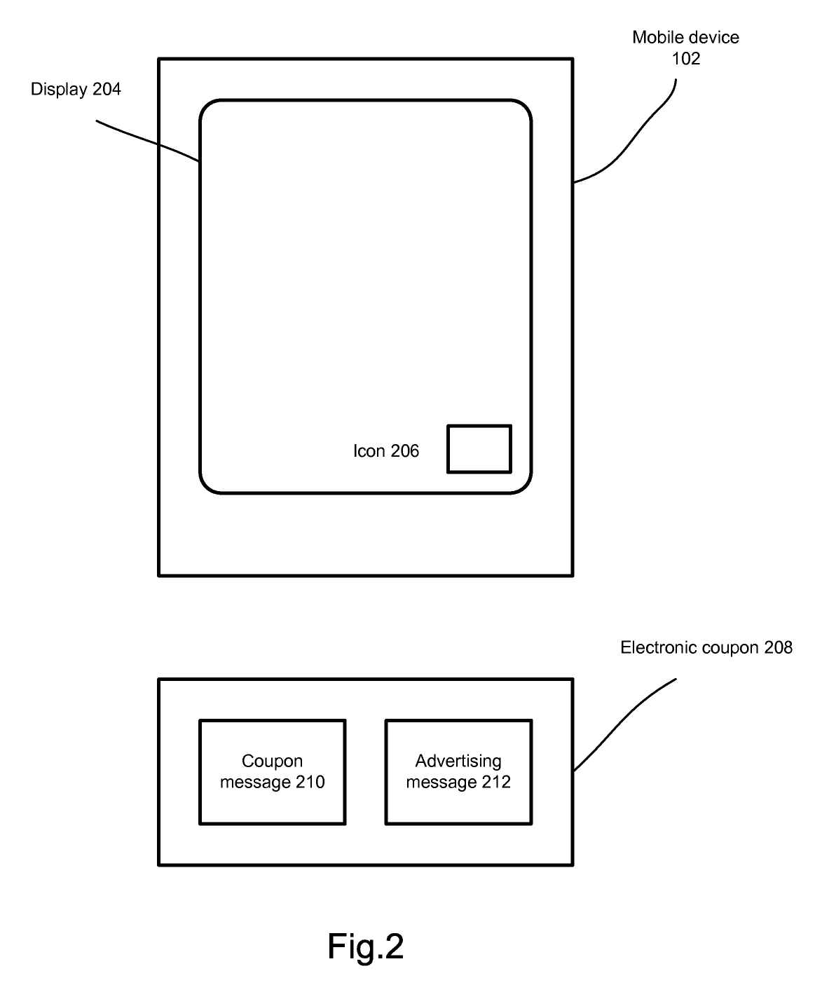

FIG. 2 is a schematic diagram illustrating exemplarily an advertising message is delivered using the mobile device. The mobile device 102 comprises a display 204. The received electronic coupon 112 is displayed as an icon 206 on the display 204. According to one implementation, the icon 206 may be displayed on a gateway page of the mobile device 102. According to another implementation, the icon may be displayed on a predetermined folder of the mobile device 102. When the icon 206 is selected by the user, the electronic coupon 112 is displayed as an image 208. The image of the electronic coupon may include a section for displaying coupon related messages 210 such as, for example, the coupon value and the expiring date. The image of the electronic coupon may also include another section for displaying the advertising message 212. The advertising message 212 may be an image comprising text, pictures, photographs and web pages. The advertising message 212 may also be a video program.

The advertising message 212 may be the one received by the user when the mobile device 102 and the electronic terminal 104 were connected. The advertising message 212 may also be the messages received by the mobile communication device 102 through a communication network after the mobile device 102 and the electronic terminal 104 were disconnected. The advertising message 212 may be updated or be replaced according to a predetermined schedule. The old messages may be replaced by new ones sent from a data manager connected to the mobile device 102 through a communication network. The data manager may be connected to one or multiple advertisers.

According to another implementation, multiple advertising messages are transmitted from the electronic terminal 104 to the mobile communication device 102 after they are connected. The advertising messages may be displayed one by one according to a predetermined scheme. The messages not being displayed may be stored in a file storage unit of the mobile device. The messages may even be stored in an invisible manner to the user.

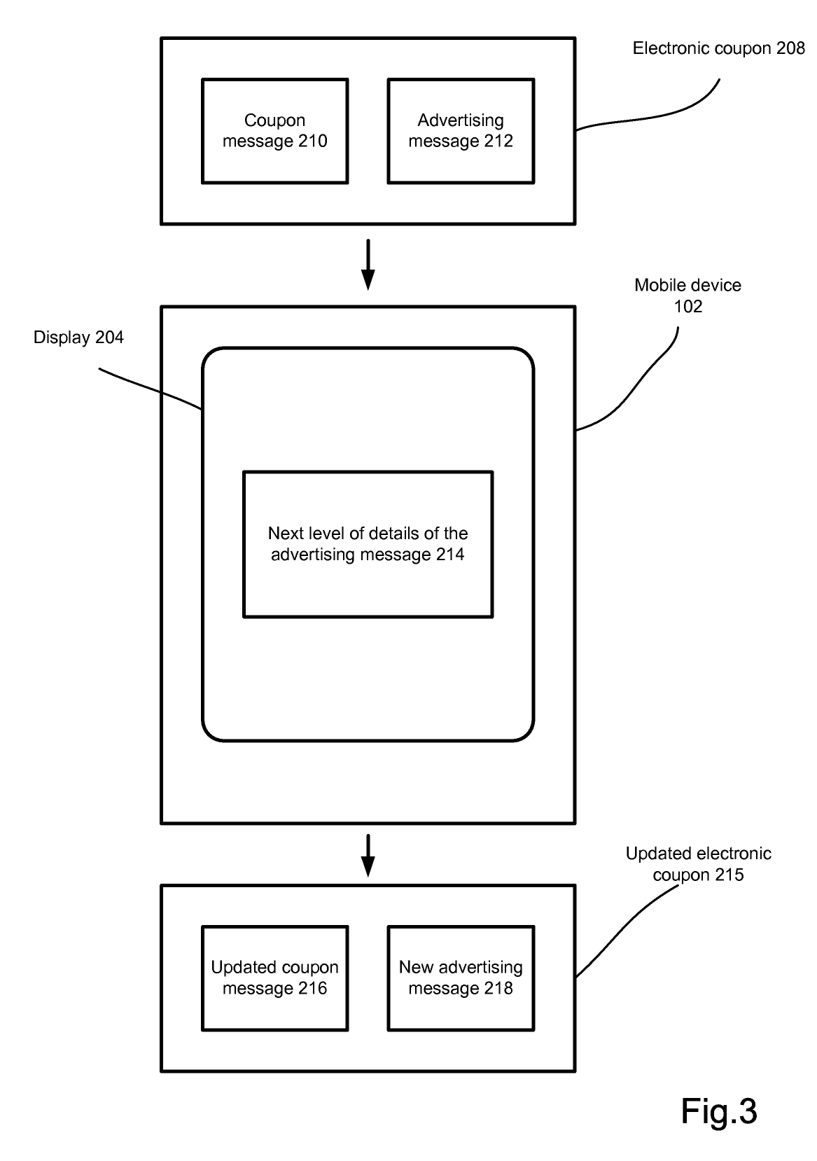

FIG. 3 is a schematic diagram illustrating operations of displaying advertising messages. The user 106 may select the advertising message 212 after it is displayed as a portion of the electronic coupon 208. According to one implementation of the present invention, the display 204 of the mobile device 102 is a touch-sensitive type of display. The user selects the advertising message by touching the displayed area for the advertising message 212 using one of his fingers. Upon selection by the user 106, the next level of details of the advertising message 214 may be displayed. According to one implementation, the displayed advertising message 212 may be a text message. The next level of the message 214 may be a video program. There are many derivatives of displaying next level of details of the message as known in the art.

After the user 106 viewed the message 214, the electronic coupon 112 may be re-displayed as an updated version of image 215. The updated image 215 further includes an updated coupon message 216. In an exemplary implementation, the coupon value may be increased as a reward for the user's action of viewing the next level of details of the advertising message. When the electronic coupon is sent from the electronic terminal 104 to the mobile device 102, a credit may be sent in accompanying with the coupon. The credit may be used to increase the value of the coupon only if the user views the next level of details of the advertising message according to one implementation. The credit may also be transmitted from the data manager connected to the mobile device 102 through the communication network. The communication network includes the Internet and a public telephone network

When the updated coupon image 215 is displayed, a new advertising message 218 may be displayed to replace the old message 212. The new messages might be delivered when the mobile device 102 and the electronic terminal 104 were connected. The new messages may be stored in a file storage unit of the mobile device 102. The new messages 218 may also be delivered from the data manager connected to the mobile device 102 through the communication network.

The redisplayed coupon image 215 may be reduced into an icon if the user's selection on the advertising message 218 is not received after a predetermined period of time.

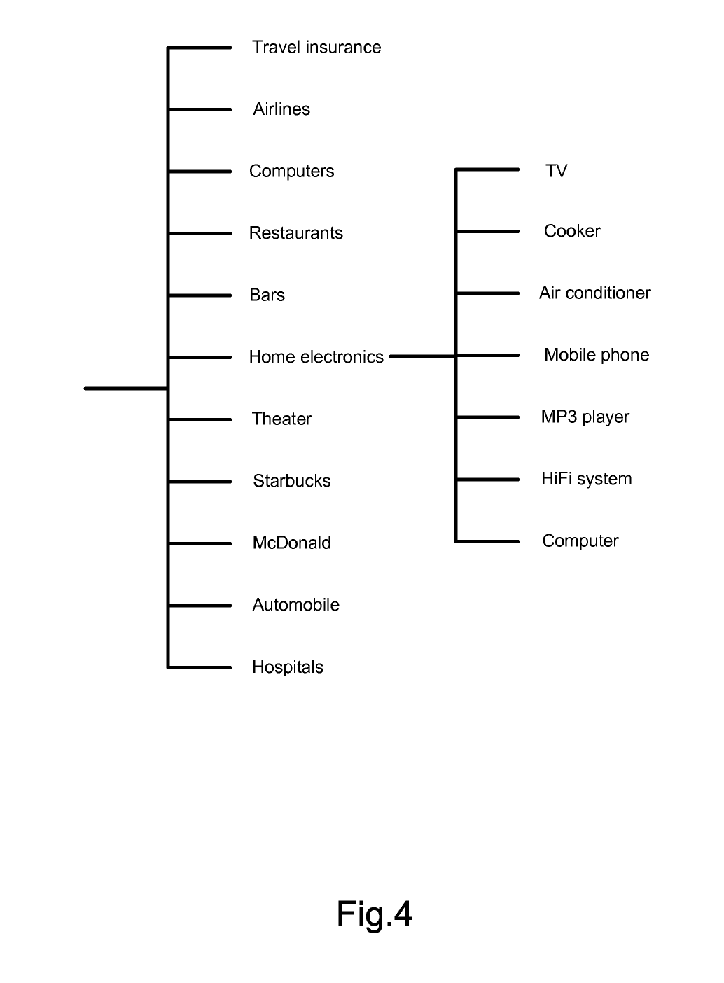

FIG. 4 is an exemplary illustration that electronic coupons may be organized into a hierarchical structure based on a hierarchical data format of the electronic coupons. The mobile device 102 may have received multiple electronic coupons from multiple retailers. The received coupons may be organized in the hierarchical manner as shown in FIG. 4. According to an exemplary implementation, the mobile device 102 may include a folder represented by an icon for electronic coupons. The folder may include multiple sub-folders. Each sub-folder represents one category of coupons and advertising messages. When a sub-folder is selected by the user, multiple icons representing received electronic coupons are displayed. The user's selection of one of the icons leads to displaying of an electronic coupon including one of the advertising messages. The coupons may be assessed easily by the hierarchical data structure of the coupons and messages.

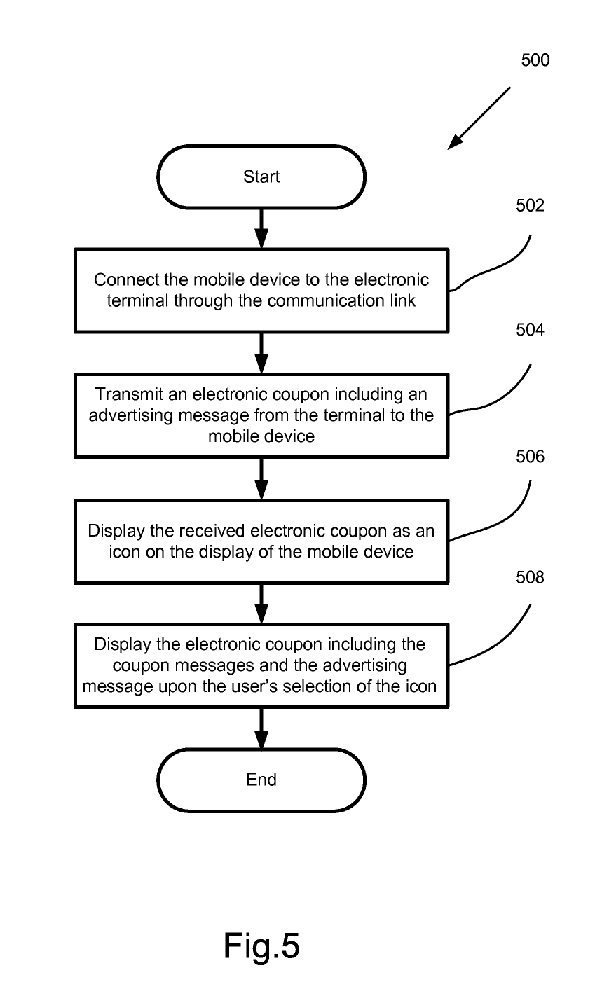

FIG. 5 is a flowchart illustrating an exemplary process that an electronic coupon including an advertising message is delivered from an electronic terminal 104 to a mobile device 102. Process 500 starts with step 502 that the mobile device 102 and the electronic terminal 104 are connected through the communication link 110. In an exemplary case, the communication link 110 is an ad hoc communication link such as, for example, the Bluetooth type of connection. The mobile communication device 102 and the electronic terminal 104 may be connected when the user 106 and the retailer 108 are engaged in a commercial transaction. According to another implementation, the mobile communication device 102 and the electronic terminal 104 may be connected through a private and/or a public communication network including the Internet and a public phone network. In step 504, the electronic coupon 112 is transmitted from the electronic terminal 104 to the mobile device 102 through the communication link 110. The electronic coupon 112 may include one or more advertising messages. In step 506, the received electronic coupon is displayed as an icon on the display 204 of the mobile device 102. The icon may be displayed on the gateway page of the mobile device. The icon may also be displayed in a predetermined folder of the mobile device 102.

It should be noted that the received electronic coupons may be displayed in other forms other than in the form of an icon. All derivatives fall into the present inventive concept. For example, the received electronic coupon may be presented as a Short-Message-Service (SMS). The received electronic coupon may also be presented as an email. The received electronic coupon may be displayed on the screen of the mobile device 102 directly instead of being displayed as an icon. According to another implementation, the received electronic coupons may also be displayed on a switching-on screen of the mobile device.

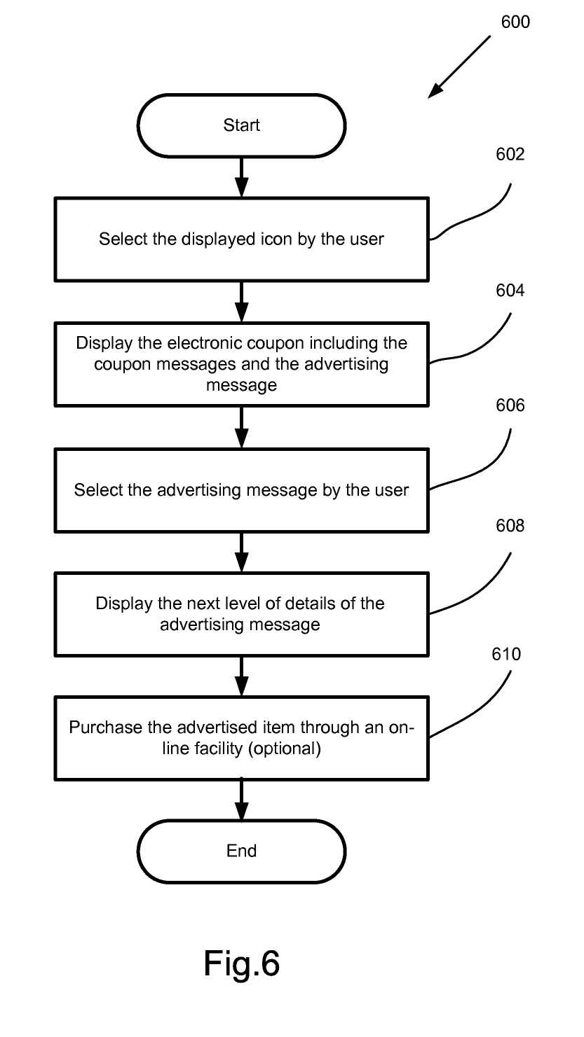

FIG. 6 is a flowchart illustrating an exemplary process that at least two levels of advertising message may be delivered to the user of the mobile device based on the electronic coupon 112. Process 600 starts with step 602 that a displayed icon 206 is selected by the user. According to one implementation of the present invention, the display 204 of the mobile device 102 is a touch-sensitive type of display. The user selects the displayed icon 206 by touching the icon using one of his fingers. In step 604, the electronic coupon 112 represented by the icon 206 is displayed on the screen of the mobile device 102. The electronic coupon 112 may include coupon related messages such as, for example, the coupon value and the expiring date. The electronic coupon 112 may also include an advertising message. The advertising message may be displayed on a predetermined portion of the coupon. The advertising message may be a text message. The advertising message may be an image. The advertising message may also be a web site. The advertising message may even be a video program. In step 606, the displayed advertising message is selected by the user. According to one implementation, the display screen is a touch-sensitive type of display. The user uses one of his fingers to make the selection. In step 608, the next level of details of the displayed advertising message is displayed. For example, if a text message is displayed as a portion of the image of electronic coupon 112, the next level of details may comprise a video program. Displaying of the next level of details may take larger portion of the screen including using the full display screen. After viewing the advertising message, the user 106 may decide to purchase the advertised item through an on-line facility in step 610. The effectiveness of the advertising may also be monitored by recording the user's action to select the icon, to select the advertising message for the next level of details and to purchase the advertised item.

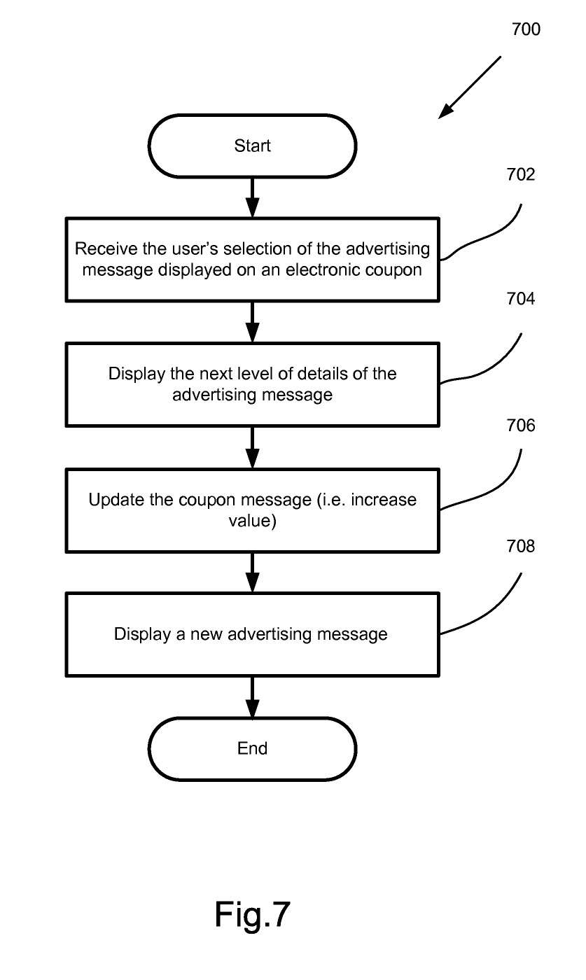

FIG. 7 is a flowchart illustrating an exemplary process that value of the coupon 112 may be increased to reward the user's action of viewing the advertising message. Process 700 starts with step 702 that the user's selection of the advertising message displayed on an image of the electronic coupon 112 is received. In step 704, the next level of details of the message is displayed. After displaying of the detailed message, in step 706, the coupon related message may be updated to reward the user's action of viewing the detailed message. For example, the value of the coupon 112 may be increased or the expiring date is extended. The electronic coupon 112 may be transmitted with additional amount of the credits. The credits may be assigned to the coupon only if the user views the coupon 112 and the advertising message. Different amount of the credits may be assigned based on the user's action to select the icon, to select the advertising message or to purchase the advertised item. The credits may also be transmitted from a data manager connected to the mobile device 102 through a communication network. The data manager may be operated by or be connected to an advertiser. A new advertising message may be displayed after the old advertising message is viewed by the user 106.

More than one advertising message may be delivered to the mobile device 102 when the coupon 112 was transmitted. The coupon may be associated with more than one advertising messages. The received advertising s may be displayed one by one. The new advertising messages may also be delivered from the data manager.

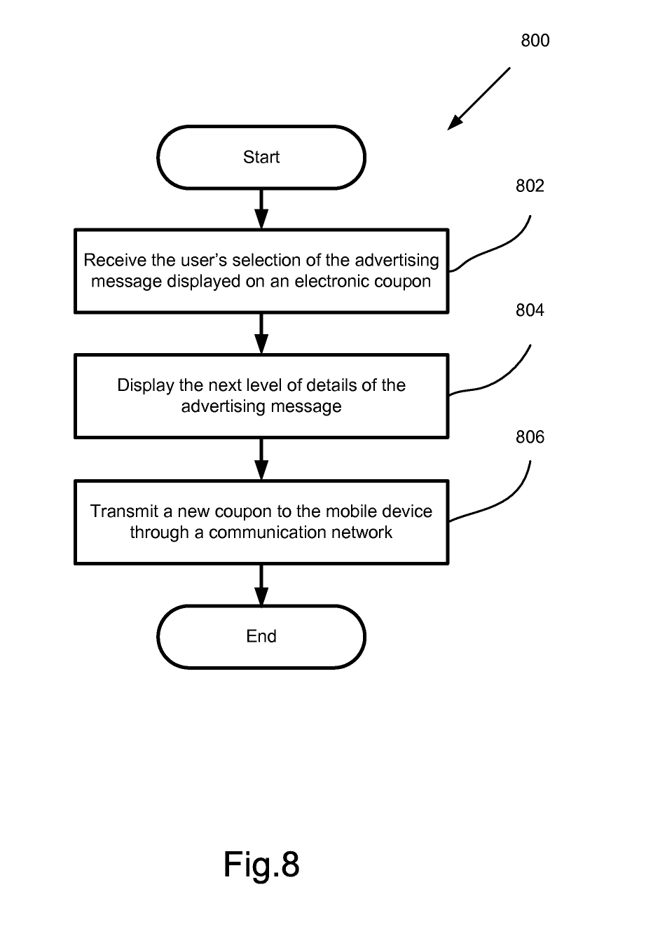

FIG. 8 is a flowchart illustrating another exemplary process that a new coupon may be delivered to the user 106 to reward the user's action of viewing the advertising message. Process 800 starts with step 802 that the user's selection of the advertising message displayed on an electronic coupon 112 is received. In step 804, the next level of details of the message is displayed. After displaying of the detailed message, in step 806, a new electronic coupon is sent to the user with a new advertising message. According to one implementation, the new electronic coupon is transmitted to the mobile device 102 through a communication network. According to another implementation, the electronic coupon was sent to the mobile device when the mobile device 102 and the electronic terminal 104 were connected. The coupon may be stored in the mobile device 102. The coupon may be invisible to the user. The new coupon becomes visible as an icon as a reward after the user views the displayed advertising message of the coupon.

1. A method of delivering advertisements from an electronic terminal to a mobile communication device carried by a user comprising:
connecting the mobile device and the electronic terminal through a communication means;
transmitting an electronic coupon including at least one advertising message from the terminal to the mobile communication device;
displaying the electronic coupon with the advertising message;
receiving the user's selection of the displayed advertising message; and
displaying next level of details of the advertising message.

2. The method as recited in claim 1, wherein said method further comprising following steps before displaying the electronic coupon:
displaying the received coupon as an icon; and
receiving the user's selection of the icon.

3. The method as recited in claim 1, wherein said method further comprising a step of increasing a value of the coupon as a reward after the user views the advertising message.

4. The method as recited in claim 1, wherein said method further comprising a step of sending another electronic coupon to the mobile communication device as a reward after the user views the advertising message.

5. The method as recited in claim 1, wherein said method further comprising a step of purchasing the advertised item through an on-line facility after the user views the advertising message.

6. The method as recited in claim 1, wherein said method further comprising replacing the advertising message through a communication network.

7. The method as recited in claim 1, wherein said communication means further comprising an ad hoc communication link conforming to one of or a combination of the follow standards:
Bluetooth (IEEE 802.15.1 and its amendments);
ZigBee (IEEE 802.15.4 and its amendments);
Wi-Fi (IEEE 802.11n); and
Near-Field-Communication (ISO/IEC 14443 and ISO 18000-3).

8. The method as recited in claim 1, wherein said communication means further including an existing communication network comprising a private communication network and/or a public communication network.

9. The method as recited in claim 1, wherein said advertising message may be related to the coupon and/or to a personalized profile of the user.

10. The method as recited in claim 1, wherein said received coupons may be organized in a hierarchical structure in the mobile communication device.

11. An advertisement delivery system comprising:
an electronic terminal;
a mobile communication device;
a communication means between the terminal and the mobile communication device; and
an electronic coupon, including at least one advertising message, transmittable between the terminal and the mobile communication device through the communication means, wherein said electronic coupon may be displayed as an icon on a display screen of the mobile device, wherein the electronic coupon may be displayed upon the user's selection of the icon, wherein next level of details of the message may be displayed upon the user's selection of the message.

12. The system as recited in claim 11, wherein said communication means further comprising an ad hoc communication link conforming to one of or a combination of the follow standards:
Bluetooth (IEEE 802.15.1 and its amendments);
ZigBee (IEEE 802.15.4 and its amendments);
Wi-Fi (IEEE 802.11n); and
Near-Field-Communication (ISO/IEC 14443 and ISO 18000-3).

13. The system as recited in claim 11, wherein said communication means further including an existing communication network comprising a private communication network and/or a public communication network.

14. The system as recited in claim 11, wherein said electronic coupon and coupons previously stored in the mobile device may be organized into a hierarchical structure.

15. The system as recited in claim 11, wherein said electronic coupon including a value and/or an expiring date displayed on the coupon, wherein the value and/or the expiring date may be changeable after the user views the advertising message.

16. The system as recited in claim 11, wherein said advertising message may be replaceable through a communication network.

17. An electronic coupon comprising a displayable image on a mobile communication device, wherein the image further comprising a displayed advertising message, wherein the next level of details of the advertising message may be displayed upon a user's selection of the displayed message, wherein the advertising message may be replaceable through a communication network.

18. The electronic coupon as recited in claim 17, wherein the electronic coupon may be transmittable between an electronic terminal and the mobile communication device through a communication means.

19. The electronic coupon as recited in claim 17, wherein said electronic coupon may have a data structure allowing stored coupons in the mobile device to be organized into a hierarchical structure.

20. The electronic coupon as recited in claim 17, wherein said electronic coupon may be displayed as an icon on a display screen of the mobile communication device.
